(19) United States
(12) Patent Application Publication
(10) Pub. No.: US 2024/0336129 A1
(43) Pub. Date: Oct. 10, 2024

(54) TWISTED COILED ACTUATOR KINEMATIC SYSTEM FOR AUTOMOTIVE AERO DEVICES

(71) Applicant: Magna Exteriors Inc., Aurora (CA)

(72) Inventors: Daniel R. Vander Sluis, Rochester Hills, MI (US); Braendon R. Lindberg, Metamora, MI (US); Jeffrey Caraway, Oxford, MI (US); Mark A. Richardson, Ortonville, MI (US)

(73) Assignee: Magna Exteriors Inc., Aurora (CA)

(21) Appl. No.: 18/628,259

(22) Filed: Apr. 5, 2024

Related U.S. Application Data
(60) Provisional application No. 63/494,833, filed on Apr. 7, 2023.

(51) Int. Cl. B60K 11/08

(52) U.S. Cl. CPC B60K 11/085

(57) ABSTRACT

An active air module for a vehicle. The module includes an active air feature having at least an open and closed position. Air is allowed to enter when in the open position and airflow is at least partially blocked in the closed position. A soft actuator such as a twisted coiled polymer actuator apparatus is used for actuation of the active air feature from the closed position to the open position.

### CROSS-REFERENCE TO RELATED APPLICATIONS

This application is a Non-Provisional Patent Application and claims benefit of U.S. Provisional Patent Application No. 63/494,833, filed Apr. 7, 2023. The disclosure of the above application is incorporated herein by reference.

### FIELD OF THE INVENTION

The present invention relates to a twisted coiled actuator kinematic system for automotive aero devices.

### BACKGROUND OF THE INVENTION

There are multiple patents for the invention of twisted coiled polymers (TCP) however nothing was found regarding specific active aero application use as outlined below. As examples twisted coiled polymer, polymer actuator, twisted coiled polymer actuator are found in WO2019106944A1, US2022026006A1 and other like patents.

Current automotive-grade actuator units for active aero modules are high-cost DC electric motor units focused on rotary drive function. These units are robust and very useful. However, the actuator motors used are heavy require control units and are expensive to integrate into an active grill system (AGS) or other active aero components. Therefore, it is a goal to provide a lightweight functional substitute for rotary drive active grill systems or other active aero devices used on vehicles.

### SUMMARY OF THE INVENTION

In the present invention there is provided a soft actuator such as twisted coiled polymer” as part of a low-cost actuator system to power the movement of an active aero module (linear, rotation, or combination) in place of an DC electric actuator. An active air module for a vehicle is provided. The active air module includes an active air feature having at least an open and closed position wherein air is allowed to enter when in the open position and airflow is at least partially blocked in the closed position. A TCP actuator apparatus for actuation of the active air feature from the closed position to the open position.

Our patent concept includes twisted coiled polymer (TCP) units which are arranged in a kinematic mechanism system that allows the TCP to act as a load generation unit for pre-loading a spring to engage in a trigger-latch mechanism also utilizing a TCP to release the trigger-latch element for each cycle of the overall system. Each cycle of our concept TCA (twisted coil actuator) kinematic mechanism outputs a linear force-load or torque capable of being used to actuate an active aero module with moving parts, such as AGS vanes. Additional patent concepts include twisted coiled polymer (TCP) units which are arranged in a pully system with a spring pre-loading the TCP in which the TCP pulls in a linear motion to actuate an active aero module vanes. Lastly a patent concept of a TCP pulling a simple lever in a linear motion to where the TCP is the driver of the motion to actuate an active aero module vanes.

Therefore, the present invention provides for use of a “twisted coiled polymer” (TCP) as part of a kinematic mechanism to actuate active aero systems.

The present invention advantageously provides a low-cost actuator utilizing TCP enabled elements and also a trigger system which is designed to be suitable for use with the with a TCP actuators.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1A (1) and 1A (3) are perspective views showing a first embodiment of an active air module for a vehicle in accordance with the present invention;

FIGS. 1A (2) and 1A (4) are perspective views of a second embodiment of an active air module for a vehicle in accordance with the present invention;

FIGS. 1B (1) and 1B (2) show a third embodiment of an active air module for a vehicle in accordance with the present invention;

FIG. 2 is a schematic view of a fourth embodiment of an active air module for a vehicle in accordance with the present invention; and

FIG. 3 is a schematic view of a fifth embodiment of an active air module for a vehicle in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention includes using a soft actuator preferably twisted coiled polymer (TCP) units which are arranged in a kinematic mechanism system that allows the TCP to act as a load generation unit for pre-loading a spring to engage in a trigger-latch mechanism also utilizing a TCP to release the trigger-latch element for each cycle of the overall system. Each cycle of our concept TCP actuator kinematic mechanism outputs a linear force-load or torque capable of being used to actuate an active aero module with moving parts, such as AGS louvers or vanes. Additional patent concepts include twisted coiled polymer (TCP) units which are arranged in a pully system with a spring pre-loading the TCP in which the TCP pulls in a linear motion to actuate an active aero module vanes. Lastly a patent concept of a TCP pulling a simple lever in a linear motion to where the TCP is the driver of the motion to actuate an active aero module vanes.

Soft actuators useful in a preferred embodiment include TCP actuators. However other actuators which may be utilized as a linear type of actuator may be utilized. Typically, soft actuators useful in the present invention exhibit shape changes when exposed to heat, light and/or electromagnetics. Examples of such actuators include shape changing actuators such as those selected from the group consisting of electro-active polymers, di-electric elastomers, shape memory allows, liquid crystal elastomer, twisted coil polymers and mixtures thereof.

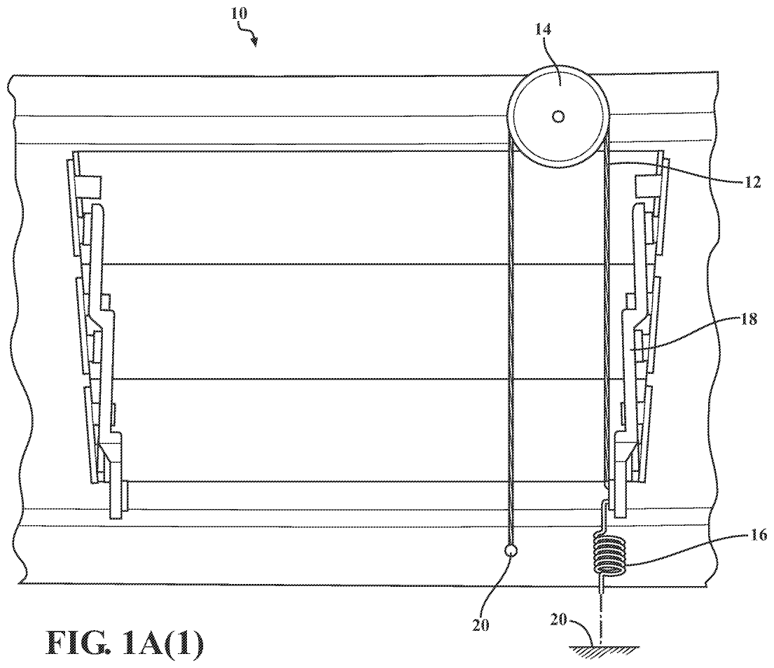

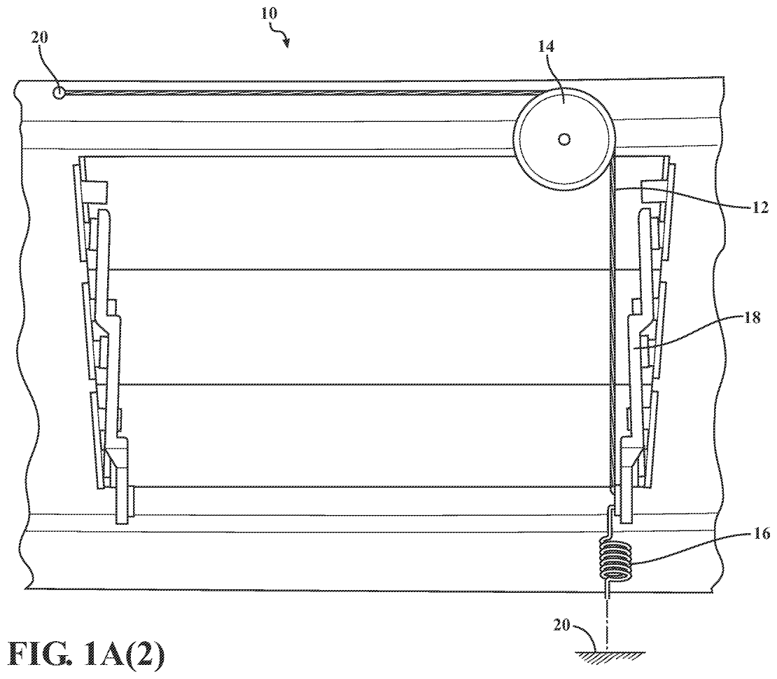

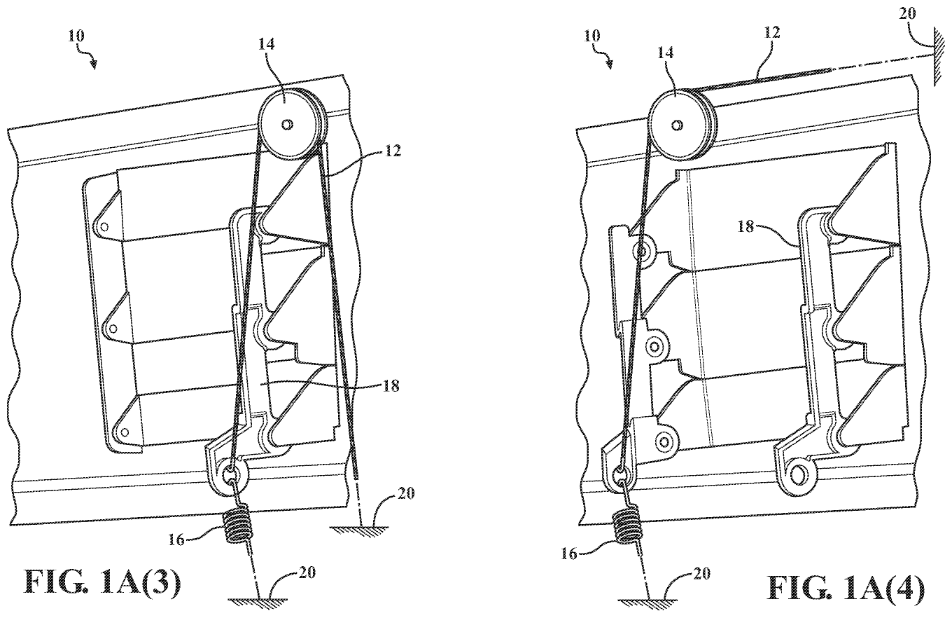

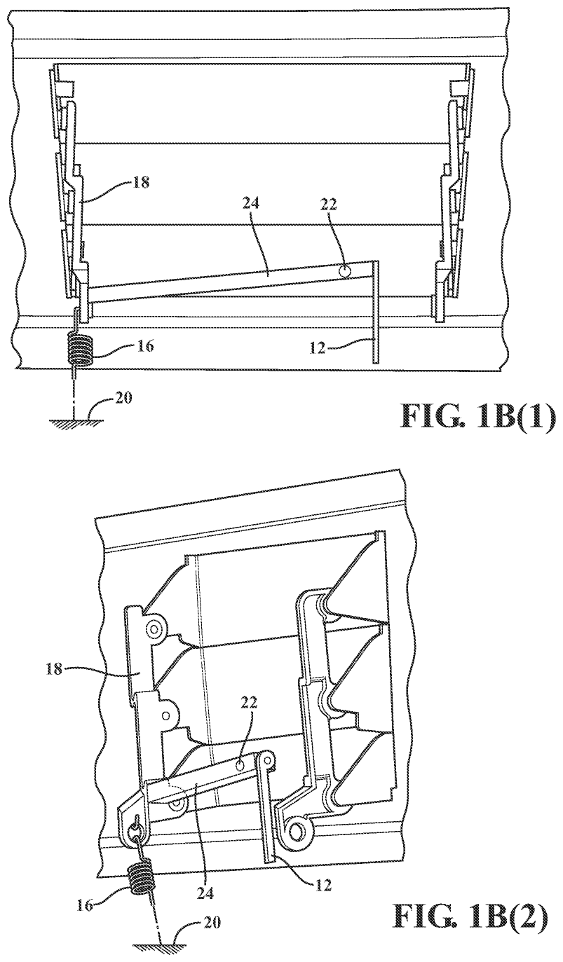

Referring now to the figures specifically FIGS. 1A (1)-1A (4) an active air module for a vehicle generally shown at 10 shows use of TCP Actuator (12) along pulley wheel (14) to open the louver system 18. Tensioner (16) keeps tension to try and keep the system in a closed status. The TCP actuator overcomes the force of the tensioner to open. Fixation (20) is the location of the attachments.

Referring now to the figures specifically FIGS. 1B (1)-1B (2) the active air module for a vehicle shows use of TCA (12) pulling lever (24) which rotates around pivot point (22). The TCA overcomes the force, and the lever shape allows for more travel to open with less travel on the TCA. Fixation (20) is the location of the attachments. In the drawings of FIGS. 1A and 1B please note that the reference numerals indicate the following elements:
12. TCA
14. Pulley wheel
16. Tensioner
18. Louver system
20. Fixation
22. Pivot point
24. Lever

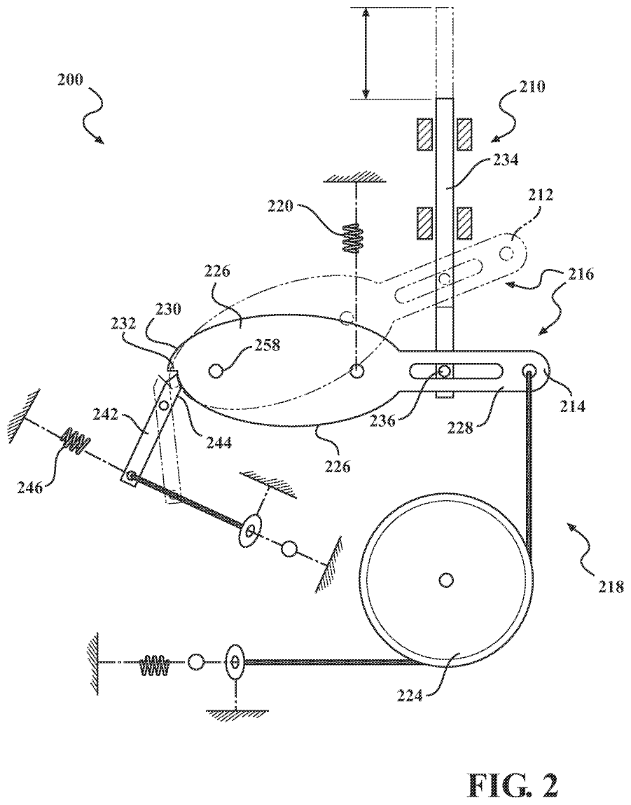

Referring now to FIG. 2, there is provided an active air module for a vehicle generally shown at 200. The active air module 200 includes an active air feature generally indicated at 210 having at least an open 212 and closed 214 positions wherein airflow 216 is allowed to enter when in the open position 212 and airflow 216 is at least partially blocked in the closed position 214.

A TCP actuator apparatus generally shown at 218 is provided for actuation of the active air feature 210 from the closed position 214 to the open position 212.

The TCP actuator apparatus 218 includes a tensioning spring 220 for biasing the active air feature towards a closed or open position and a TCP A is used to overcome the tensioning spring 220. Spring 222 is provided at the anchor point of the TCP A to provide tensioning such that the TCP A is tensioned but buffered from forces which might harm the TCP A strand. The TCP A is used to overcome the biasing in the opposite direction as the spring bias provided by spring 220. As shown in this embodiment a pulley wheel 224 is used for directing the TCP A and allowing a compact package which provides a long enough length of TCP to actuate the TCP apparatus. A pivotal actuator arm 226 including a lever end 228 and a cam end 230, the cam end 230 includes a catch 232 for holding the lever end 228 in an open or closed position. The lever end 228 is attached to a movable air closure device 234 by way of a pin 236 which rides in an elongated slot 238 and biased in a first open or closed direction. The closure device can be a direct sliding door, or a load transfer link attached to another opening and closing structure such as a louver assembly in an AGS (active grill) system. The pivotal actuator arm 226 is pivoted at the pivot point 238 which moves the lever arm 228 up and down for opening or closing of the device.

A trigger set assembly 242 is provided which includes a second TCP B member which engages a sear pawl 244 for holding of the active air feature in a set position (which is closed in FIG. 2). The sear pawl 244 is biased by spring 246 for engaging the cam end 230 at catch 232. This allows for retaining the active air feature in the open position and “cocked” for returning to the closed position upon triggering the sear pawl. In operation TCP A cocks the assembly to the closed position. When it is necessary to open the assembly tension, is let off of TCP A and TCP B is contracted to release the sear pawl 244 which allows spring 220 to contract and open the air feature by moving load transfer link 234.

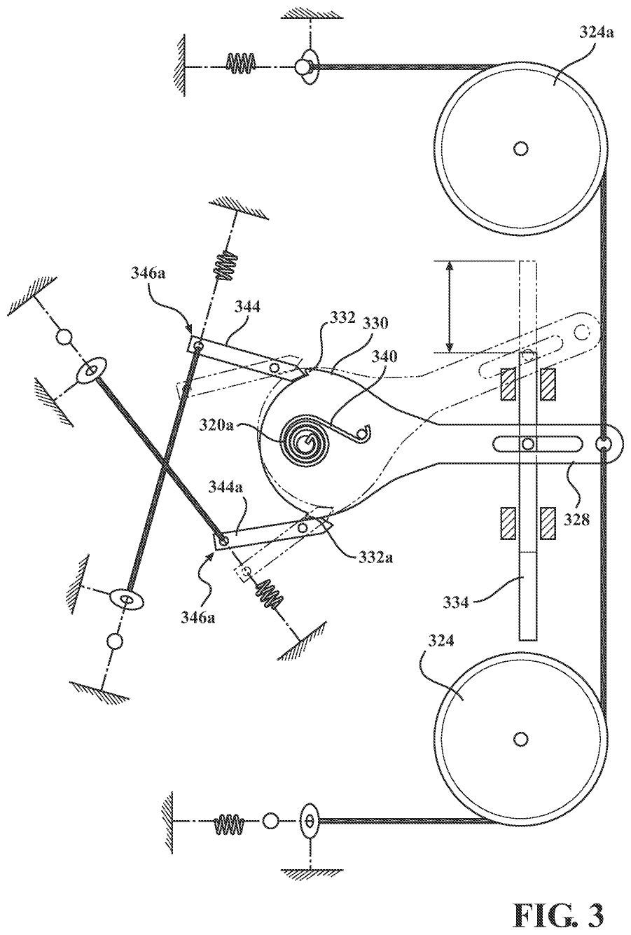

In another embodiment shown in FIG. 3 (where numbers differing by 100 from FIG. 2 show like elements therein) is provided. In this embodiment a pair of TCP actuators TCP A and TCP B are used for providing controlled opening and closing using the load transfer lever 334. Two trigger arrangements 344 and 344a provide locking points with the catches 332 and 332a. In this embodiment a normally centered clock spring 320a is provided around the pivot point 340 and will provide bidirectional biasing such that the apparatus can be cocked in either the open or closed positions. The trigger pawls are actuated by TCP C and TCP D actuators. As will be readily appreciated by those skilled in the art, a suitable controller (not shown) is used for providing the proper sequencing of the various TCP actuators in order to achieve desired opening and closing of the active air feature. As will be readily appreciated while it is preferred to use twisted pair TCP actuator. However, a single strand is also within the scope of the present invention.

Twisted and coiled polymer actuators are a form of soft actuator that are composed of nylon sewing thread or fishing line and use joule heating to contract or expand in length. The strands of polymer are twisted under load to produce a spring-like structure. Joule heating is the process of converting electrical energy to thermal energy through power dissipation by a resistor. For TCP actuators, voltage is applied (approximately 10V) to the coils and the current drawn heats the structure. Nylon thread has a negative thermal expansion in the axial direction, which provides a way to have reversible contractions by heating. Thus, a suitable electronic controller which can be an engine or vehicle control system can send the appropriate currents to the TCP Actuators for for contracting and expanding the TCP actuators and thereby controlling opening or closing of the active grill system or other active aero system.

Therefore, the present invention provides for use of a “twisted coiled polymer” (TCP) as part of a kinematic mechanism to actuate active aero systems.

The present invention advantageously provides a low-cost actuator utilizing TCP enabled elements and also a trigger system which is designed to be suitable for use with the with a TCP actuators.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. An active air module for a vehicle comprising:
an active air feature having at least an open and closed module for a vehicle comprising position wherein air is allowed to enter when in the open position and airflow is at least partially blocked in the closed position; and
a shape changing actuator apparatus for actuation of the active air feature from the closed position to the open position.

2. The active air module of claim 1 wherein said shape changing actuator is a twisted coil polymer (TCP) actuator.

3. The active air module of claim 1 wherein the actuator apparatus includes a tensioning spring for biasing the active air feature towards a closed or open position and a TCP is used to overcome the biasing in the opposite direction as the spring bias.

4. The active air module of claim 2 further comprising a trigger set assembly which includes a second TCP member which engages a sear pawl for holding of the active air feature in a set position, said sear pawl biased for engaging the active air feature for retaining it in the open or closed position acting against the tensioning spring.

5. The active air module of claim 3 wherein the actuator apparatus includes a pivotal actuator including a lever and a cam end, the cam end includes a catch for holding the lever in an open or closed position, the lever end is attached to a moveable air closure device and biased in a first open or closed direction, a first TCP actuator is attached to the lever end for moving against the spring for cocking the mechanism in the preselected open or closed direction wherein the trigger pawl engages the catch in the cam for holding of the lever in the preselected open or closed position, a second TCP actuator attached to the trigger pawl for selectively triggering the lever for moving of the air closure device to the other of the open or closed position when releasing the pawl.

6. The active air module of claim 4 wherein a third TCP actuator is provided for providing movement to the lever arm in the opposite direction of the first TCP actuator thereby providing controlled actuation of the actuator for moving the lever arm into both the open and closed directions.

7. The active air module of claim 5 wherein the cam end includes a second catch, and a second trigger pawl is provided for engaging the second catch; a fourth TCP is provided for actuation of the second trigger pawl for holding the cam cocked in the other of the open or closed positions.

8. The active air module of claim 5 wherein a clock spring is provided for biasing of the cam in each of the open or closed positions to provide a cocked position in each of said open and closed positions.

9. The active air module of claim 1 wherein a belt and pully system opens and closes a louver module and said TCP actuator is in line with said belt.

10. The active air module of claim 1 wherein a lever is used for actuating a louver module and said TCP actuator is used to pull on an end of said lever for actuating of said louver module.

11. The active air module of claim 1 wherein the shape changing actuator is a soft actuator.

12. The active air module of claim 1 wherein the shape changing actuator is selected from the group consisting of electro-active polymers, di-electric elastomers, shape memory allows, liquid crystal elastomer, twisted coil polymers and mixtures thereof.

13. An active air module for a vehicle comprising:
an active air feature having at least an open and closed position wherein air is allowed to enter when in the open position and airflow is at least partially blocked in the closed position; and
a twisted coil polymer (TCP) actuator apparatus for actuation of the active air feature from the closed position to the open position.

14. The active air module of claim 13 wherein the actuator apparatus includes a tensioning spring for biasing the active air feature towards a closed or open position and a TCP is used to overcome the biasing in the opposite direction as the spring bias.

15. The active air module of claim 14 further comprising a trigger set assembly which includes a second TCP member which engages a sear pawl for holding of the active air feature in a set position, said sear pawl biased for engaging the active air feature for retaining it in the open or closed position acting against the tensioning spring.

16. The active air module of claim 15 wherein the actuator apparatus includes a pivotal actuator including a lever and a cam end, the cam end includes a catch for holding the lever in an open or closed position, the lever end is attached to a moveable air closure device and biased in a first open or closed direction, a first TCP actuator is attached to the lever end for moving against the spring for cocking the mechanism in the preselected open or closed direction wherein the trigger pawl engages the catch in the cam for holding of the lever in the preselected open or closed position, a second TCP actuator attached to the trigger pawl for selectively triggering the lever for moving of the air closure device to the other of the open or closed position when releasing the pawl.

17. The active air module of claim 16 wherein a third TCP actuator is provided for providing movement to the lever arm in the opposite direction of the first TCP actuator thereby providing controlled actuation of the actuator for moving the lever arm into both the open and closed directions.

18. The active air module of claim 17 wherein the cam end includes a second catch, and a second trigger pawl is provided for engaging the second catch; a fourth TCP is provided for actuation of the second trigger pawl for holding the cam cocked in the other of the open or closed positions.

19. The active air module of claim 17 wherein a clock spring is provided for biasing of the cam in each of the open or closed positions to provide a cocked position in each of said open and closed positions.

20. The active air module of claim 13 wherein a belt and pully system opens and closes a louver module and said TCP actuator is in line with said belt.

21. The active air module of claim 13 wherein a lever is used for actuating a louver module and said TCP actuator is used to pull on an end of said lever for actuating of said louver module.
